(19) United States
(12) Patent Application Publication
(10) Pub. No.: US 2003/0031317 A1
(43) Pub. Date: Feb. 13, 2003

(54) Increasing the size of a data-set and watermarking

(76) Inventor: Michael Epstein, Spring Valley, NY (US)

Correspondence Address: Corporate Patent Counsel, U.S. Philips Corporation, 580 White Plains Road, Tarrytown, NY, 10591, US

(21) Appl. No.: 09/928,677

(22) Filed: Aug. 13, 2001

(51) Int. Cl. H04N 7/167

(52) U.S. Cl. 380/202

(57) ABSTRACT

Some security processes call for the addition of data to the content material that is to be protected. The addition of such data may, however, cause anomalous behavior in subsequent processes that are designed to process the content material only. The data that is to be added to content material is preprocessed using a preprocessor that has, as its output, a signal that conforms to the general characteristics of the content material. This preprocessed additional data is then added to the original content material. By preprocessing the additional data, the combined material is assured to be compatible with subsequent postprocessors of the combined material, such as a watermarking process.

### BACKGROUND OF THE INVENTION

1. Field of the Invention

This invention relates to the field of data protection, and in particular to protecting data from illicit copying from a remote location.

2. Description of Related Art

The protection of data is becoming an increasingly important area of security. In many situations, the authority to copy or otherwise process information is verified by evaluating the encoding of copy-protected material for particular characteristics. For example, copy-protected material may contain watermarks or other encodings that identify the material as being copy-protected, and also contains other encodings that identify whether this particular copy of the material is an authorized copy, and whether it can be copied again. For example, an authorized copy of content material may contain a robust watermark and a fragile watermark. The robust watermark is intended to be irremovable from the encoding of the content material. Attempting to remove the watermark causes damage to the content material. The fragile watermark is intended to be damaged when the content material is illicitly copied. For example, common fragile watermarks are damaged if the content material is compressed or otherwise altered. In this manner, content material that is compressed in order to be efficiently communicated via the Internet will be received with a robust watermark and a damaged fragile watermark. A content-processing device that is configured to enforce copy protection rights in this example will be configured to detect the presence of a robust watermark, and prevent the processing of the content material containing this robust watermark unless the fragile watermark is also present.

Generally, a watermarking process is particularly tailored to the general characteristics of the content material. For example, in the frequency domain, the watermark is configured to lie within the baseband of the original content material. Spatial masking is used to render the watermark material inaudible, even though it is in the baseband of the original content material. A watermarking of a video signal, on the other hand, requires a different type of masking to assure that it does not create visible distortion in the rendered images. In like manner, the watermarking of data, such as a text file, will require a different type of masking to assure that it does not adversely affect the processing of the data by typical application programs.

In some security systems, data is added to the original content material, generally before watermarking, as illustrated in FIG. 1. This figure illustrates a conventional concatenation of content material 110 and data 120 to form a composite data file 150 that is provided to a watermarking system 180. Note, however, that the combination of a data-addition and watermarking, can often be problematic. If the data 120 is added before the watermarking, and if the data 120 does not have the same general characteristics of the content material 110, the composite data and content material 150 may be incompatible with the watermarking process 180, or, the watermarking process 180 may adversely affect the added data 120. For example, if the added data 120 has frequency components beyond the baseband of the content material 110, then the watermarking process 180 may filter out these components before applying the watermark, thereby distorting the data 120. Or, if the watermarking process 180 does not contain a filter, the out-of-baseband components of the data 120 may cause aliasing when the watermarking process 180 is applied. This aliasing will likely produce frequency components in the baseband of the content material 110, thereby causing a distortion of the content material 110 and/or a distortion of the watermark.

### BRIEF SUMMARY OF THE INVENTION

It is an object of this invention to provide a security process and apparatus for the protection of content material via the addition of data. It is a further object of this invention to provide a security process and apparatus that allows for the watermarking of the combination of the content material and the additional data.

These objects and others are achieved by pre-processing the data that is to be added to the content material, using a preprocessor that has, as its output, a signal that conforms to the general characteristics of the content material. This preprocessed additional data is then added to the original content material. By preprocessing the additional data, the combined material is assured to be compatible with subsequent postprocessors of the combined material, such as a watermarking process.

### BRIEF DESCRIPTION OF THE DRAWINGS

The invention is explained in further detail, and by way of example, with reference to the accompanying drawings wherein:

FIG. 1 illustrates an example prior art concatenation process for adding data to content material.

FIG. 2 illustrates an example block diagram of a processing system for adding data to content material in accordance with this invention.

FIG. 3 illustrates an example block diagram of an audio encoding system in accordance with this invention.

Throughout the drawings, the same reference numerals indicate similar or corresponding features or functions.

### DETAILED DESCRIPTION OF THE INVENTION

A common method of misappropriating content material is to copy the material from its original media, such as the original purchased CD containing the content material, and providing it to others. Such misappropriated content material is often made available from a remote source, via the Internet. Often, for ease of downloading, individual songs are downloaded from the Internet, rather than the entire set of material constituting the material on the original media. This invention is presented using a misappropriation of material via the Internet as a paradigm for the means of obtaining unauthorized material, although the principles of this invention are applicable to copy-protection schemes in general, without regard to how the unauthorized material is obtained.

A variety of techniques may be employed to assure that the content material is provided from the original purchased CD, rather than from a downloaded copy of the content material. As noted above, the use of fragile watermarking facilitates the detection of a compression and subsequent decompression of the original content material, based on the assumption that, for efficient downloading via the Internet, the illicit copy of the original content material will be compressed, using for example, an MP3 encoding. With increased access speeds to the Internet, however, it becomes increasingly feasible to download individual songs in an uncompressed form, thereby preserving the fragile watermark, and avoiding this security safeguard.

Copending U.S. patent application “Protecting Content from Illicit Reproduction by Proof of Existence of a Complete Data Set via a Linked List”, U.S. Ser. No. 09/537,079, filed Mar. 28, 2000 for Antonius A. M. Staring and Michael A. Epstein, Attorney Docket US000088, teaches the prevention of access to a subset of a data-set unless the presence of an entirety of the data-set is verified. In this manner, for example, an entire CD would need to be downloaded before the system would allow access to a single song. This copending application teaches a self-referential data set that facilitates the determination of whether the entirety of the data set is present. This copending application creates a linked list of sections of a data set, encodes the link address as a watermark of each section, and verifies the presence of the entirety of the data set by verifying the presence of the linked-to sections of some or all of the sections of the data set.

Copending U.S. patent application “Protecting Content from Illicit Reproduction by Proof of Existence of a Complete Data Set via Self-Referencing Sections”, U.S. Ser. No. 09/536,944, filed Mar. 28, 2000 for Antonius A. M. Staring, Michael A. Epstein, and Martin Rosner, Attorney Docket US000040, teaches a self-referential data set wherein each section of a data set is uniquely identified and this section identifier is associated with each section in a secure manner. To assure that a collection of sections are all from the same data set, an identifier of the data set is also securely encoded with each section. Preferably, the section identifier and the data set identifier are encoded as a watermark that is embedded in each section, preferably as a combination of robust and fragile watermarks. Using exhaustive or random sampling, the presence of the entirety of the data set is determined, either absolutely or with statistical certainty.

In each of these copending applications, if the entirety of the data set is not present, subsequent processing of the data items of the data set is terminated. Random sampling techniques may be employed to verify the presence of the entirety to a desired level of confidence, without verifying the presence of each byte or segment of the entire data set. In the context of digital audio recordings, a compliant playback or recording device is configured to refuse to render an individual song in the absence of verification that the entire contents of the CD is present.

The time required to download an entire album on a CD in uncompressed digital form, even at DSL and cable modem speeds, can be expected to be greater than an hour, depending upon network loading and other factors. Thus, by requiring that the entire contents of the CD be present, at a download “cost” of over an hour, the likelihood of a theft of a song via a wide-scale distribution on the Internet is substantially reduced.

To further discourage the downloading of an entirety of the data set, the size of the data set can be increased by adding bytes to the original content material. That is, for example, a typical audio CD may be encoded with as much as 650 megabytes of data. If a particular collection of songs does not amount to the full capacity of a CD, data can be added to create a data set on the CD that consumes the entire amount. Preferably, random data bytes are added, to further frustrate attempts to compress the data set, or other attempts to avoid this security measure. This random data will be associated with the entirety of the data set, as additional segments within the data set. Alternatively, non random data, such as a particular security code, or a set of instructions that effect particular actions on select rendering devices, and so on, may be added as well.

As noted above, although additional data may easily be concatenated with the original content material to form a composite data set, anomalous behavior may occur when the combination of the data and the original content material is presented to a post processor, such as a watermarking system. This anomalous behavior may affect the decoding of the original content material, the added data, or the watermark, or a combination of each. This anomalous behavior will be caused by characteristics of the random data that do not conform to the expected or implied characteristics of the original content material. As noted above, the non-conformance will typically be exhibited as frequency components that are beyond the characteristic baseband of the original content material, although other non-conforming characteristics may also be present.

In accordance with this invention, the data that is added to the original content material is constrained to be compliant with the characteristics of the encoded content material. Preferably, this compliance is achieved by submitting the added data to the same encoding process that is used to produce the encoded content material. For example, a standard encoding form for an audio CD is a “Redbook” encoding. If the content material is encoded in a Redbook form, in a preferred embodiment of this invention, the added data is also encoded via a Redbook encoder.

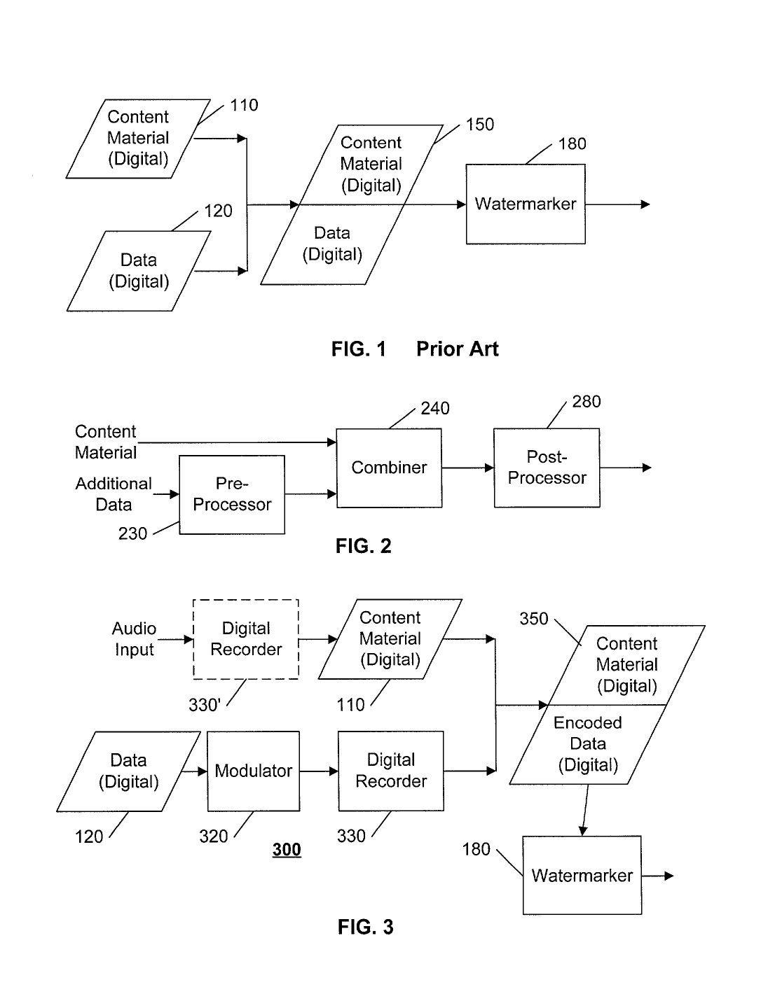

FIG. 2 illustrates an example block diagram of an encoding system in accordance with this invention. The system comprises a preprocessor 230, and a combiner 240. The system is configured to provide a composite output that is compatible with a post-processor 280 that is compatible with the original content material. That is, if the post-processor 280 is a watermarking system (180 in FIG. 1) that is configured to create watermarks for Redbook encoded audio data, the system is configured to assure that the combination of the content material and the added data conforms to the Redbook standard, regardless of the characteristics of the added data. In a straightforward embodiment using this example, the added data may be an analog audio noise signal that is provided to a convention Redbook encoder as the preprocessor 230. In a more complex embodiment, the added data may be binary digits, and the preprocessor 230 is configured to convert this data into an audio input to a conventional Redbook encoder. The combiner 240 combines the original content material and the preprocessed data from the preprocessor 230 to produce the combined output, typically as a concatenation of the original content material and the preprocessed data. Preferably, the portion of the combined output that corresponds to the preprocessed data is suitably distinguished from the original content material, so that a conventional playback device will not attempt to render the preprocessed data into an audible form.

FIG. 3 illustrates an example block diagram of an encoding system 300 in accordance with this invention that is configured to encode added digital data, such as random bytes, into a form that is suitable for watermarking. In this example, the digital data 120 is provided to a modulator 320 that is configured to convert binary digits into audio tones. The modulator 320, for example, may be a conventional modem that converts binary digits into tones that are transmitted over a telephone line. The audio output from the modulator 320 is provided to a conventional digital recorder 330 that encodes the audio output into a form that is compatible with the form of the content material. As illustrated by the dashed block 330′, the digital recorder 330 is preferably the same type of recorder 330′ that an audio performer might have used to provide the original content material 110. By using the same recording scheme, the output of the recorder 330 is assured to be compatible with the output of the recorder 330′ (i.e. the content material 110). Thereby, the combination 350 of the content material 110 and the encoded data from the recorder 330, is known to be compatible with the watermarking system 180 that is compatible with the output of the recorder 330′. It is then a simple matter to watermark the combination 350 as a single data set.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the examples provided above used audio recordings as the paradigm application for this invention, the principles of this invention may be applied to any encoding scheme. In a DVD encoding, for example, the added data may be random visual or audio noise, or a combination of both, that is encoded into the same video format as the content material, or it may be random bits that are converted to audio and/or visual information that is subsequently encoded into the required video format. These and other system configuration and optimization features will be evident to one of ordinary skill in the art in view of this disclosure, and are included within the scope of the following claims.

I claim:

1. An encoding system for adding data to encoded content material, the encoded content material having defined characteristics, comprising:
a preprocessor that is configured to encode the data to form encoded data that conforms to the defined characteristics of the encoded content material, and
a combiner that is configured to combine the encoded content material and the encoded data to form a combined encoded output that conforms to the defined characteristics of the encoded content material.

2. The encoding system of claim 1, further comprising:
a postprocessor that is configured to process an input that is consistent with the defined characteristics of the encoded content material, and wherein
the combined encoded output is provided as the input to the postprocessor.

3. The encoding system of claim 2, wherein
the postprocessor includes a watermarking system.

4. The encoding system of claim 3, wherein
the watermarking system is configured to provide at least one of: a fragile watermark and a robust watermark, based on the combined encoded output.

5. The encoding system of claim 1, wherein
the data comprises an analog noise signal, and
the preprocessor is configured to receive the analog noise signal and to produce therefrom the encoded data as a digital encoding.

6. The encoding system of claim 5, wherein
the analog noise signal is at least one of: an audio noise and a visual noise.

7. The encoding system of claim 1, wherein
the data comprises a digital signal, and
the preprocessor is configured to receive the digital signal, and includes:
a modulator that converts the digital signal to an analog signal, and
an encoder that processes the analog signal to form the encoded data as a digital encoding.

8. The encoding system of claim 7, wherein
the encoder is substantially equivalent to a device that provides the encoded content material having the defined characteristics.

9. The encoding system of claim 8, wherein
the encoder comprises at least one of: a CD encoder and a DVD encoder.

10. The encoding system of claim 1, wherein
the combiner is configured to concatenate the encoded content material and the encoded data to form the combined encoded output.

11. The encoding system of claim 1, wherein
the encoding system is configured to provide the data, based on a random process.

12. An encoding method for adding data to encoded content material, the encoded content material having defined characteristics, comprising:
preprocessing the data to form encoded data that conforms to the defined characteristics of the encoded content material, and
combining the encoded content material and the encoded data to form a combined encoded output that conforms to the defined characteristics of the encoded content material.

13. The encoding method of claim 12, further comprising
postprocessing the combined encoded output via a process that is compatible with the defined characteristics of the encoded content material.

14. The encoding method of claim 13, wherein
the postprocessing includes watermarking the combined encoded output.

15. The encoding method of claim 14, wherein
the watermarking provides at least one of: a fragile watermark and a robust watermark, based on the combined encoded output.

16. The encoding method of claim 12, wherein
the data comprises an analog noise signal, and
the preprocessing includes receiving the analog noise signal and producing therefrom the encoded data as a digital encoding.

17. The encoding method of claim 16, wherein
the analog noise signal is at least one of: an audio noise and a visual noise.

18. The encoding method of claim 12, wherein
the data comprises a digital signal, and
the preprocessing includes receiving the digital signal, and includes:
modulating the digital signal to form an analog signal, and
encoding the analog signal to form the encoded data as a digital encoding.

19. The encoding method of claim 18, wherein
the encoding is substantially equivalent to an encoding process that provides the encoded content material having the defined characteristics.

20. The encoding method of claim 19, wherein
the encoding process corresponds to at least one of: a CD encoding process and a DVD encoding process.

21. The encoding method of claim 12, wherein
the combining includes concatenating the encoded content material and the encoded data to form the combined encoded output.

22. The encoding method of claim 12, further including
generating the data based on a random process.
